(19) United States
(12) Patent Application Publication
(10) Pub. No.: US 2022/0294540 A1
(43) Pub. Date: Sep. 15, 2022

(54) DEVICE COMMUNICATION THROUGH HAPTIC VIBRATIONS

(71) Applicant: Sony Interactive Entertainment Inc., San Mateo, CA (US)

(72) Inventors: Glenn Black, San Mateo, CA (US); Michael Taylor, San Mateo, CA (US)

(21) Appl. No.: 17/200,078

(22) Filed: Mar. 12, 2021

(51) Int. Cl. H04B 11/00; H04L 29/06

(52) U.S. Cl. CPC H04B 11/00; H04L 63/0428

(57) ABSTRACT

Devices can network with each other via haptic vibrations that propagate through one or more other physical objects so that each device can sense haptic vibrations from another device, determine messages being communicated through the haptic vibrations, and execute functions based on the messages.

### FIELD

The present application relates generally to technically inventive, non-routine solutions that are necessarily rooted in computer technology and that produce concrete technical improvements. In particular, the present application relates to using haptic vibrations to establish a network between devices for device communication.

### BACKGROUND

As recognized herein, there may be instances where communication between various electronic devices may be desirable to execute a function at one or more of the devices. However, as also recognized herein, if the devices have not been electrically networked together for such communication then they cannot communicate. Additionally, there may be instances where electrically networking the devices together can be too slow and technically challenging. There are currently no adequate solutions to the foregoing computer-related, technological problem.

### SUMMARY

Accordingly, the present application discusses a network and/or mode of communication in which devices can communicate with each other via haptic vibrations that propagate through one or more other physical objects. In this way, each device can sense haptic vibrations from another device and determine a message being communicated through the haptic vibrations.

Accordingly, in one aspect a first device includes at least one processor, an accelerometer accessible to the at least one processor, and storage accessible to the at least one processor. The storage includes instructions executable by the at least one processor to receive at least one signal from the accelerometer, identify a series of vibrations indicated via the at least one signal, and identify a communication from a second device based on the series of vibrations. The second device is different from the first device. The instructions are then executable to take at least one action at the first device based on the communication.

Thus, in one example the instructions may be executable to determine zeros and ones from the series of vibrations and analyze the zeros and ones to identify the communication.

Also in an example, the instructions may be executable to identify an encrypted communication from the second device based on the series of vibrations, decrypt the communication, and take the at least one action at the first device based on the decrypted communication.

Additionally, in some example embodiments the instructions may be executable to identify vibrations of different frequencies and/or amplitudes based on the at least one signal and then identify an analog communication from the second device based on the identified vibrations of different frequencies and/or amplitudes.

In some example implementations, the at least one action may include synchronizing a clock or current time of day maintained at the first device based on a time indicated in the communication. Additionally or alternatively, the at least one action may include providing a notification at the first device that a text message has been received at a third device different from the first and second devices.

Still further, in some examples the communication may indicate an encryption key, and the at least one action may include storing the encryption key locally at the first device. The encryption key may be usable to decrypt additional communications from the second device. In some instances, the additional communications may not be identified based on at least one signal from the accelerometer and may instead be received over another network.

Additionally, if desired the first and second devices may not share a wired electrical connection or a wireless electrical connection while the accelerometer senses the series of vibrations and while the communication is identified based on the series of vibrations.

Also, note that in some examples the first and second devices may both be wireless video game controllers.

Still further, if desired the communication may indicate a password and the instructions may be executable to provide, via wireless electronic communication, the password to a wireless access point for the first device to join a network through the wireless access point.

In another aspect, a computer-implemented method includes identifying a series of haptic vibrations using a motion sensor on a first device and identifying data communicated from a second device based on the series of haptic vibrations. The second device is different from the first device. The method also includes executing at least one function at the first device based on the data identified based on the series of haptic vibrations.

In still another aspect, an apparatus includes at least one computer readable storage medium (CRSM) that is not a transitory signal. The CRSM includes instructions executable by at least one processor to actuate at least one vibrator in a device to transmit a message via vibration.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 shows a side elevational illustration of an example involving two devices sitting on a table top and communicating via haptic vibrations consistent with present principles;

FIG. 3 illustrates example logic in example flow chart format for a device to send a message or other data via haptic vibrations consistent with present principles;

FIG. 4 illustrates example logic in example flow chart format for a device to receive a message or other data via haptic vibrations consistent with present principles;

FIGS. 5-7 show various example graphical user interfaces (GUIs) that may be presented on a display of a device that has received a message or other data via haptic vibrations consistent with present principles;

FIG. 8 shows an example GUI that may be presented on a display of a device based on a user providing a command to transmit an encryption key via haptic vibrations consistent with present principles; and

FIG. 9 shows an example GUI that may be presented on a display to configure one or more settings of a device to operate consistent with present principles.

### DETAILED DESCRIPTION

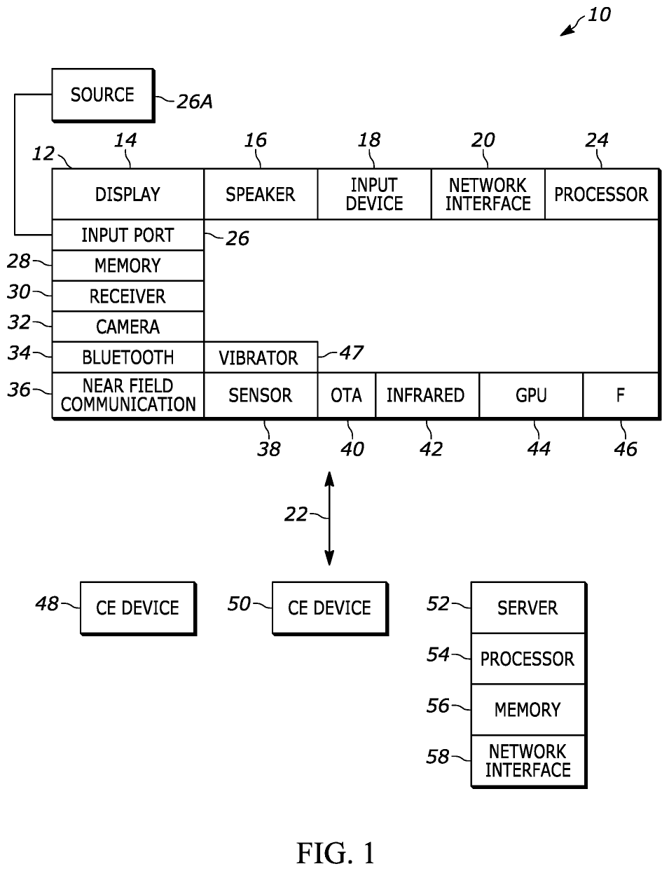

Now referring to FIG. 1, this disclosure relates generally to computer ecosystems including aspects of computer networks that may include consumer electronics (CE) devices. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below.

Servers and/or gateways may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security.

As used herein, instructions refer to computer-implemented steps for processing information in the system. Instructions can be implemented in software, firmware or hardware and include any type of programmed step undertaken by components of the system.

A processor may be a general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library. While flow chart format may be used, it is to be understood that software may be implemented as a state machine or other logical method.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

Now specifically referring to FIG. 1, an example system 10 is shown, which may include one or more of the example devices mentioned above and described further below in accordance with present principles. Note that computerized devices described in all of the figures herein may include some or all of the components set forth for various devices in FIG. 1.

The first of the example devices included in the system 10 is a consumer electronics (CE) device configured as an example primary display device, and in the embodiment shown is an audio video display device (AVDD) 12 such as but not limited to an Internet-enabled TV with a TV tuner (equivalently, set top box controlling a TV). The AVDD 12 may be an Android®-based system. The AVDD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVDD 12 and/or other computers described herein may be configured to undertake present principles (e.g. communicate with other devices to undertake present principles, execute the logic described herein, and perform any other functions and/or operations described herein).

Accordingly, to undertake such principles the AVDD 12 can be established by some or all of the components shown in FIG. 1. For example, the AVDD 12 can include one or more displays 14 that may be implemented by a high definition or ultra-high definition “4K” or higher flat screen and that may or may not be touch-enabled for receiving user input signals via touches on the display. The AVDD 12 may also include one or more speakers 16 for outputting audio in accordance with present principles, and at least one additional input device 18 such as e.g. an audio receiver/microphone for e.g. entering audible commands to the AVDD 12 to control the AVDD 12. The example AVDD 12 may further include one or more network interfaces 20 for electronic communication over at least one network 22 such as the Internet, an WAN, an LAN, a PAN etc. under control of one or more processors 24. Thus, the interface 20 may be, without limitation, a Wi-Fi transceiver, which is an example of a wireless computer network interface, such as but not limited to a mesh network transceiver. The interface 20 may also be, without limitation a Bluetooth transceiver, Zigbee transceiver, IrDA transceiver, Wireless USB transceiver, wired USB, wired LAN, Powerline or MoCA. It is to be understood that the processor 24 controls the AVDD 12 to undertake present principles, including the other elements of the AVDD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVDD 12 may also include one or more input ports 26 such as, e.g., a high definition multimedia interface (HDMI) port or a USB port to physically connect (e.g. using a wired connection) to another CE device and/or a headphone port to connect headphones to the AVDD 12 for presentation of audio from the AVDD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or the source 26a may be a game console or disk player.

The AVDD 12 may further include one or more computer memories 28 such as disk-based or solid-state storage that are not transitory signals, in some cases embodied in the chassis of the AVDD as standalone devices or as a personal video recording device (PVR) or video disk player either internal or external to the chassis of the AVDD for playing back AV programs or as removable memory media. Also, in some embodiments, the AVDD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVDD 12 is disposed in conjunction with the processor 24. However, it is to be understood that that another suitable position receiver other than a cellphone receiver, GPS receiver and/or altimeter may be used in accordance with present principles to e.g. determine the location of the AVDD 12 in e.g. all three dimensions.

Continuing the description of the AVDD 12, in some embodiments the AVDD 12 may include one or more cameras 32 that may be, e.g., a thermal imaging camera, a digital camera such as a webcam, and/or a camera integrated into the AVDD 12 and controllable by the processor 24 to gather pictures/images and/or video in accordance with present principles. Also included on the AVDD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVDD 12 may include one or more auxiliary sensors 38 (e.g., a motion sensor such as an accelerometer, gyroscope, cyclometer, or a magnetic sensor, an infrared (IR) sensor for receiving IR commands from a remote control, an optical sensor, a speed and/or cadence sensor, a gesture sensor (e.g. for sensing gesture command), etc.) providing input to the processor 24. The AVDD 12 may include an over-the-air TV broadcast port 40 for receiving OTA TV broadcasts providing input to the processor 24. In addition to the foregoing, it is noted that the AVDD 12 may also include an infrared (IR) transmitter and/or IR receiver and/or IR transceiver 42 such as an IR data association (IRDA) device. A battery (not shown) may be provided for powering the AVDD 12.

Still further, in some embodiments the AVDD 12 may include a graphics processing unit (GPU) 44 and/or a field-programmable gate array (FPGA) 46. The GPU and/or FPGA may be utilized by the AVDD 12 for, e.g., artificial intelligence processing such as training neural networks and performing the operations (e.g., inferences) of neural networks in accordance with present principles. However, note that the processor 24 may also be used for artificial intelligence processing such as where the processor 24 might be a central processing unit (CPU).

As also shown in FIG. 1, the AVDD 12 may include one or more vibrators 47. Each of the vibrators 47 may be established by an electric motor connected to an off-center and/or off-balanced weight via the motor's rotatable shaft. The shaft may then rotate under control of the motor (which in turn may be controlled by a processor such as the processor 24) to create vibration of various frequencies and/or amplitudes consistent with present principles.

Still referring to FIG. 1, in addition to the AVDD 12, the system 10 may include one or more other computer device types that may include some or all of the components shown for the AVDD 12. In one example, a first device 48 and a second device 50 are shown and may include similar components as some or all of the components of the AVDD 12. Fewer or greater devices may be used than shown.

The system 10 also may include one or more servers 52. A server 52 may include at least one server processor 54, at least one computer memory 56 such as disk-based or solid state storage, and at least one network interface 58 that, under control of the server processor 54, allows for electronic communication with the other devices of FIG. 1 over the network 22, and indeed may facilitate electronic communication between servers, controllers, and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server and may include and perform “cloud” functions such that the devices of the system 10 may access a “cloud” environment via the server 52 in example embodiments. Or the server 52 may be implemented by a game console or other computer in the same room as the other devices shown in FIG. 1 or nearby.

The devices described below may incorporate some or all of the elements described above.

The methods described herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a CD ROM or Flash drive. The software code instructions may alternatively be embodied in a transitory arrangement such as a radio or optical signal, or via a download over the Internet.

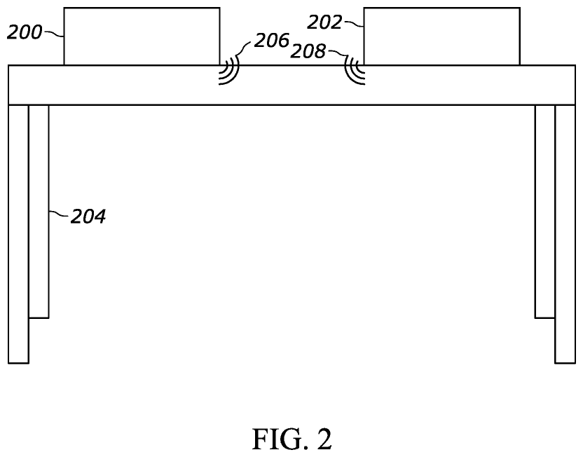

Turning now to FIG. 2, it shows an example side elevational view of two devices 200, 202 sitting on a top surface of a table 204 or other tangible, real-world object(s) through which vibrations may travel between the devices 200, 202. For example, other real-world objects through which vibrations may travel between the devices 200, 202 might include a kitchen counter, a bench, a wireless charging pad, a vehicle's center console, a floor, etc.

Thus, as also shown in FIG. 2, both devices 200, 202 are generating respective vibrations 206, 208 that may travel through the table's wood or other material and to the other respective device 200, 202, which may in turn sense the respective vibrations using its own accelerometer or other motion sensor. Consistent with present principles, vibrations from one of the devices of FIG. 2 to the other device may indicate a communication from the sending device to the receiving device.

The devices 200, 202 themselves may be any number of client devices such as wireless video game controllers and/or smart phones, for example. E.g., the device 200 may be a video game controller and the device 202 may be another input device or gaming console accessory that is resting on the table 204.

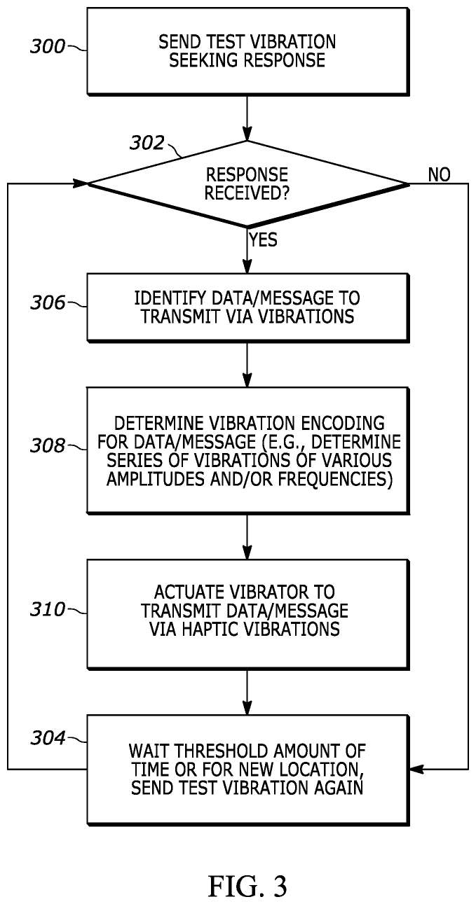

Turning now to FIG. 3, it shows example logic that may be executed by a first device such as one of the devices 200, 202 or another client device as described herein in order to communicate with one or more other devices via vibrations that travel through one or more solid state mediums such as a table top consistent with present principles. However, also note that in some examples vibrations may be sensed by a respective device even as they travel through a liquid or gas medium capable of translating vibrations that may be sensed by the other respective device(s).

Beginning at block 300, the first device may send a test vibration seeking a response from at least one other device, including a second device in this example. The test vibration may be used so that the first device knows another device can sense its vibrations before it starts indiscriminately trying to communicate via vibrations, which can consume processor resources and drain the first device's battery. The test vibration may be one or more vibrations of a predetermined length, frequency, amplitude and/or pattern that is recognizable by other devices as a test vibration based on the other devices being preprogrammed to recognize as much. For example, the test vibration may be a series of short equal-length vibration bursts of a predetermined frequency and amplitude as emitted within a predetermined time frame, where those bursts would not be recognized by the other device(s) as communication of anything other than the test vibration itself (such as communication of characters of a subsequent message as will be described further below). If desired, in embodiments where the first and second devices are also in infrared (IR) signal communication with each other, like if both devices are wireless video game controllers having IR transceivers, the two devices may also exchange test IR signals/responses via their IR transceivers to gain even more confidence that vibration communication is being initiated between devices that are proximate enough to transmit IR signals.

From block 300 the logic may then proceed to decision diamond 302 where the first device may determine whether a response to the test vibration has been received at the first device (e.g., from the second device per this example). The vibration(s) of the response may be sensed by an accelerometer or other motion sensor on the first device. In some examples, the response vibration may be of the same predetermined length, frequency, amplitude and/or pattern as the test vibration itself. It may therefore be recognized as a response to the test vibration if received within a threshold time of the first device sending the test vibration (e.g., within ten seconds), and otherwise may be recognized by the first device as an initial test vibration to which the first device should respond if beyond the threshold time. However, in the alternative the response from the second device may be of a different predetermined length, frequency, amplitude and/or pattern that is uniquely recognizable as a test vibration response.

If a negative determination is made at diamond 302, the logic may proceed to block 304. At block 304 the first device may wait a threshold amount of time before sending a test vibration again, such as waiting ten minutes or one hour or another predetermined amount of time to save battery power rather than continually sending out test vibrations hoping for a response. Additionally or alternatively but to also save battery power at block 304, the first device may wait until it has determined it is in a different location before sending a test vibration again, as may be determined using a GPS transceiver on the first device, using the first device's motion sensor and dead reckoning to determine it has changed locations, using triangulation based on communication with two or more other devices, etc. From block 304 the logic may then return to decision diamond 302 and proceed therefrom.

Once an affirmative determination is made at diamond 302, the logic may instead proceed to block 306. At block 306 the first device may identify a message or other data to transmit to the second device via vibrations generated at the first device that may then travel through one or more vibration mediums (such as the table 204) to be sensed by the second device. Thus, the tangible object(s) between and physically linking the two devices through one or a series of physical contact points may therefore act as a communication medium and help establish an ad-hoc network between the two devices, even if the two devices do not share a wired electrical or wireless electrical connection such as through an ethernet cable or Wi-Fi link.

As for the message or data itself that is identified at block 306, it may be a message or data the first device has been preprogrammed to send in response to receipt of a response to the test vibration, such as clock data indicating a current time of day as maintained at the first device or a password for the second device to access whatever local Wi-Fi network the first device is already currently connected to via an access point. However, further note that in some examples the message or data may contain data specifically requested by the second device in one or more additional vibrations from the second device as sensed at the first device subsequent to sensing the response vibration. From block 306 the logic may proceed to block 308.

At block 308 the first device may determine vibration encoding for the message or data identified at block 306. The encoding may be in digital or analog form but in either case may use a predetermined protocol as determined by a developer or manufacturer of the devices, for example.

For example, if digital communication is to be used, first and second vibrations of different frequencies, different amplitudes, and/or different durations may be used to communicate zeros and ones, respectively. In this way, the second device may identify a sequence of zeros and/or ones as being communicated by the first device based on an identified sequence of the first and second vibrations as produced by the first device. Thus, digital communication may be enabled even without an electrical connection between the two devices.

If analog communication is to be used, various vibrations of different frequencies, different amplitudes, and/or different durations may be used to communicate different numerical digits or alphabetical text characters that may help form the data or message. For example, a vibration communication protocol may be established by a programmer or developer that associates a different respective vibration(s) of a certain amplitude, frequency, and/or duration with a respective alphabetical or numerical character so that first device may actuate its vibrator to indicate a series of characters through a series of vibrations to send the message. The associations themselves between different vibrations and different characters may be stored in a relational database accessible to the first and second devices, such as in local storage of each respective device.

Once encoding has been determined, the logic may proceed to block 310 where the first device may actuate its vibrator to actually transmit the message or data via haptic vibrations that may travel across the one or more objects/mediums that physically connect or are between the two devices.

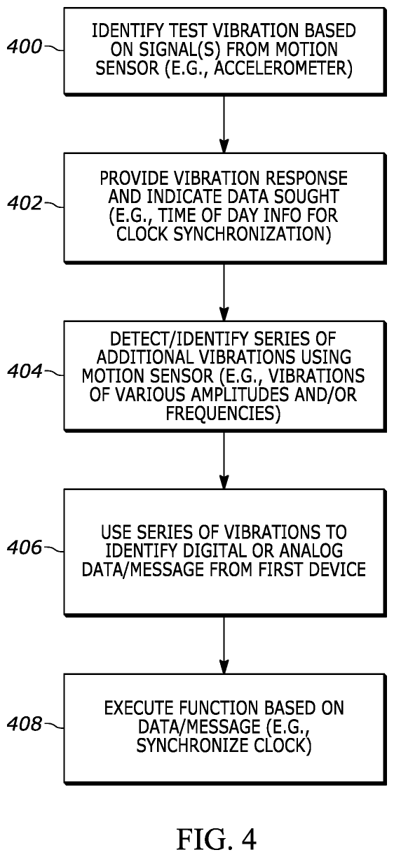

Continuing now in reference to FIG. 4, it shows example logic that may be executed by the second device described above in reference to FIG. 3 to communicate with the first device of FIG. 3. Beginning at block 400, the second device may identify a test vibration from the first device using signals from the second device's motion sensor that indicate it has sensed the vibration. The logic may then proceed to block 402.

At block 402 the second device may provide a response to the test vibration as described above and may also indicate via additional vibrations any specific data it might be seeking, such as the current time of day as maintained at the first device so that the second device can synchronize the clock it maintains locally to the clock of the first device. Clock synchronization might be particularly useful in computer gaming and other scenarios that use eye tracking, such as augmented reality or virtual reality scenarios. Time-based synchronization of cameras for eye tracking may be used to determine eye positions and eye movement of different users that occur at a same time and may be used for facilitating gameplay or other types of audio-video content interaction. As other examples, the second device may request a Wi-Fi password to join a local Wi-Fi network, or request a symmetrical or asymmetrical encryption key to then securely communicate with the first device using an electrical connection such as a Wi-Fi or Internet connection using the key.

From block 402 the logic may then move to block 404. At block 404 the second device may detect or identify a series of additional vibrations (beyond the test vibration) using its motion sensor. Again note that the motion sensor of the second device may sense the additional vibrations as generated by the vibrator in the first device based on the additional vibrations travelling through one or more other physical objects coupling the first device to the second device. From block 404 the logic may then proceed to block 406.

At block 406 the second device may use the series of additional vibrations its motion sensor has sensed to identify a digital or analog message from the first device. Again note that a predetermined digital or analog communication protocol as set forth above may be used for identifying the message from the additional vibrations themselves. Also note that in some examples the message or data may be transmitted by the first device and received by the second device in encrypted form and so the second device may decrypt the communication (as encrypted with the second device's public key) using the second device's private key. In some examples, the first and second devices may know which encryption keys are to be used based on the first and second devices exchanging public keys when also exchanging the test vibration and response as discussed above. After block 406 the logic may then proceed to block 408.

At block 408 the second device may execute a function based on the received message or data (e.g., in decrypted form). For example, at block 408 the second device may synchronize its clock to indicate a current time of day that matches the current time of day maintained by a clock running at the first device. The clock synchronization may be used to synchronize to within a tenth or hundredth of a second, for example, depending on the implementation and/or needs in a specific application as may be specified by a developer or the device manufacturer.

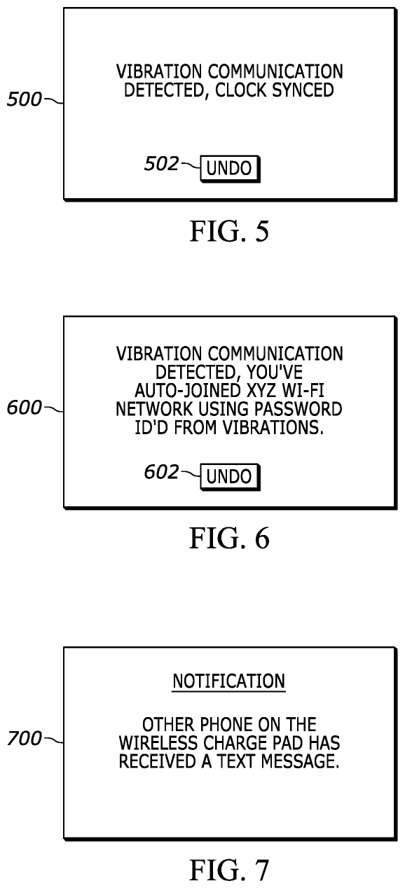

FIGS. 5-7 show various graphical user interfaces (GUIs) that may be presented on the display of the second device after block 408 and responsive to executing an associated function at block 408 itself. As shown in FIG. 5, a GUI 500 may indicate that a vibration communication from another device has been detected and that a digital clock maintained at the second device has been synced with a digital clock maintained at the first device as described above. However, if for some reason a user did not wish the second device to take that action, an undo selector 502 may be selected to command the second device to revert its clock to a current time of day the second device had maintained prior to being changed based on the vibration communication.

FIG. 6 shows another example where the second device has autonomously joined a Wi-Fi network by wirelessly communicating a password to an access point for the Wi-Fi network, where the password itself was received from the first device via vibrations communicated to the second device as described herein. Thus, a GUI 600 may be presented on the display of the second device and indicate that a vibration communication from another device has been detected and that the second device has automatically joined a local Wi-Fi network named “XYZ” using a password indicated in the vibration communication. However, here too if for some reason a user did not wish the second device to take this action, an undo selector 602 may be selected to command the second device to disconnect from the Wi-Fi network it has joined.

Moving on to FIG. 7, in this case a GUI 700 is presented on the display of the second device to indicate that a vibration communication has been received from the first device that indicates that a third device has received a short message service (SMS) text message. Thus, in this example suppose that the third device is a smartphone and that the first device is a wireless charging pad or other device charger that may be electronically paired with the third device so that the first device knows when the third device has received a text message (or alternatively, email message, social media message, telephone call, etc.). Responsive to identifying that the third device has received the text message, the wireless charging pad may actuate a vibrator inside of it to let other nearby devices (including the second device) know that the third device has received a text message. Thus, the second device need not be electronically paired with either of the first or third devices to exchange certain information, making device communication faster while avoiding burdensome pairing steps and the need to learn a new user interface and also avoiding the need to download a new application for communication with the first and/or third devices.

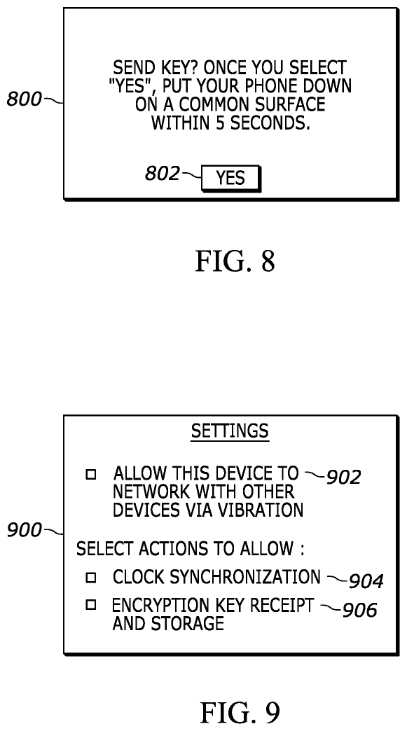

Turning now to FIG. 8, yet another example GUI 800 is shown but in this case the GUI 800 may be presented on the display of the first device of FIGS. 3 and 4 based on a user of the first device providing a command to transmit an encryption key to another device. As may be appreciated from FIG. 8, the GUI 800 instructs the user to confirm that the user wishes to send the encryption key and indicates that once the user selects the selector 802 to confirm, the user has five seconds (or another predefined period of time) to place the first device down on a common surface on which the other device is also disposed so that the encryption key may be communicated to the other device via vibration after giving the user sufficient time to provide confirmation and put the device down. Thus, once the user selects the selector 802 and the predefined period of time transpires, the first device may begin using its vibrator to transmit a message indicating the encryption key to one or more other devices resting on the common surface. This may be particularly useful to transmit sensitive encryption keys (or securely transmit other sensitive data) without using a purely electrical data connection between the two devices that might be susceptible to hackers, ensuring that only devices within close physical proximity to the first device to sense its vibrations can identify communication of the key. Based on the foregoing, it may be further appreciated that in some example embodiments, the devices sensing vibrations through a common surface(s) they are touching may be used as one factor as part of two-factor authentication or multi-factor authentication for secure data exchange. Then once the key has been received by the receiving device, they key may be stored locally at the receiving device and may then be used to encrypt additional communications to the first device but possibly as sent over another network such as a Wi-Fi or Internet network.

Continuing the detailed description in reference to FIG. 9, it shows an example settings GUI 900 that may be presented on the display of a device configured to undertake present principles. For example, a smartphone, video game controller, or other device may be programmed with the logic of both FIGS. 3 and 4 to both send and receive vibration communications as disclosed herein, and thus the GUI 900 may be presented at such a device to configure one or more settings for operation of vibration communications.

As shown in FIG. 9, the GUI 900 may include a first option 900 that may be selectable by directing touch or cursor input to the adjacent check box in order to set or configure the device to undertake present principles. For example, the option 900 may be selected to set or enable the device to, in the future, execute the logic of both FIGS. 3 and 4. If the option 900 is not selected, vibration communication may be disabled.

As also shown in FIG. 9, the GUI 900 may further include a listing of respective options associated with particular actions or functions the device may execute based on vibration communication. Any possible action or function the device has been configured to execute based on vibration communications may be listed on the GUI 900 (including any of those described herein), but for simplicity only two options 904, 906 are shown. Option 904 may be selected to select clock/current time of day synchronization as a function to execute based on vibration communication, while option 906 may be selected to select receipt and storage of an encryption key transmitted via vibration communication as the function to execute.

It may now be appreciated that present principles make use of possibly non-electrical physical objects to efficiently establish an ad-hoc network between devices without the devices having to be electronically paired together or otherwise establishing a purely electrical connection, thereby improving efficient communication between computerized devices. Vibration frequency and/or amplitude modulation may be used for the devices to communicate with each other using physical haptic signals, where one device may generate a modulated vibration signal which can be identified by the other device using the other device's accelerometer. Present principles may be used for communications in a one-to-one scenario between only two devices, or may be used in still other scenarios including many-to-one embodiments where plural devices communicate messages to another device or one-to-many embodiments where a single device communicates messages to plural other devices.

As but one more example consistent with present principles, suppose multiple people are sitting around a coffee table and are ready to start playing a common video game together on their respective devices, with gameplay for each person starting at the same time. All devices may be initially placed on the coffee table so that vibration messages can be exchanged in order to sync the clocks of the respective devices for gameplay. Once synced, the clocks may then be used to initiate the game at the respective device at the same time the game is initiated at the other respective devices so that everyone starts playing the game at the same time without having to undertake the burdensome task of having to pair or otherwise have their devices electrically communicate over a Wi-Fi or Internet network.

It will be appreciated that whilst present principals have been described with reference to some example embodiments, these are not intended to be limiting, and that various alternative arrangements may be used to implement the subject matter claimed herein.

What is claimed is:

1. A first device, comprising:
at least one processor;
an accelerometer accessible to the at least one processor; and
storage accessible to the at least one processor, the storage comprising instructions executable by the at least one processor to:
receive at least one signal from the accelerometer;
identify a series of vibrations indicated via the at least one signal;
identify a communication from a second device based on the series of vibrations, the second device being different from the first device; and
take at least one action at the first device based on the communication.

2. The first device of claim 1, wherein the instructions are executable to:
determine zeros and ones from the series of vibrations; and
analyze the zeros and ones to identify the communication.

3. The first device of claim 1, wherein the instructions are executable to:
identify an encrypted communication from the second device based on the series of vibrations;
decrypt the communication; and
take the at least one action at the first device based on the decrypted communication.

4. The first device of claim 1, wherein the instructions are executable to:
identify vibrations of different frequencies and/or amplitudes based on the at least one signal; and
identify an analog communication from the second device based on the identified vibrations of different frequencies and/or amplitudes.

5. The first device of claim 1, wherein the at least one action comprises synchronizing a clock maintained at the first device based on a time indicated in the communication.

6. The first device of claim 1, wherein the at least one action comprises providing a notification at the first device that a text message has been received at a third device different from the first and second devices.

7. The first device of claim 1, wherein the communication indicates an encryption key, and wherein the at least one action comprises storing the encryption key locally at the first device, the encryption key being usable to decrypt additional communications from the second device.

8. The first device of claim 7, wherein the additional communications are not identified based on at least one signal from the accelerometer and are instead received over another network.

9. The first device of claim 1, wherein the first and second devices do not share a wired electrical connection or a wireless electrical connection while the accelerometer senses the series of vibrations and while the communication is identified based on the series of vibrations.

10. The first device of claim 1, wherein the first and second devices are both wireless video game controllers.

11. The first device of claim 1, wherein the communication indicates a password, and wherein the instructions are executable to:
provide, via wireless electronic communication, the password to a wireless access point for the first device to join a network through the wireless access point.

12. A computer-implemented method, comprising:
identifying a series of haptic vibrations using a motion sensor on a first device;
identifying data communicated from a second device based on the series of haptic vibrations, the second device being different from the first device; and
executing at least one function at the first device based on the data identified based on the series of haptic vibrations.

13. The method of claim 12, wherein the at least one function comprises synchronizing a current time of day maintained at the first device based on a time indicated in the data.

14. The method of claim 12, wherein the data indicates a password, and wherein the method comprises:
providing, using the first device, the password to a wireless access point for the first device to join a network through the wireless access point, the wireless access point established by a third device that is different from the first and second devices.

15. The method of claim 12, comprising:
determining a series of zeros and ones based on the series of haptic vibrations; and
executing the at least one function based on data indicated via the series of zeros and ones.

16. The method of claim 12, comprising:
identifying haptic vibrations of different frequencies and/or amplitudes using the motion sensor; and
identifying the data based on the haptic vibrations of different frequencies and/or amplitudes.

17. The method of claim 12, wherein the motion sensor comprises an accelerometer.

18. An apparatus, comprising:
at least one computer readable storage medium (CRSM) that is not a transitory signal, the CRSM comprising instructions executable by at least one processor to:
actuate at least one vibrator in a device to transmit a message via vibration.

19. The apparatus of claim 18, wherein the instructions are executable by the at least one processor to:
determine vibrations of various amplitudes and/or frequencies to generate using the at least one vibrator in order to communicate a predetermined series of characters and/or digits via the vibrations; and
actuate the at least one vibrator to transmit the message via the vibrations, the message indicating the predetermined series of characters and/or digits.

20. The apparatus of claim 18, comprising the device and comprising the at least one vibrator.
